(19) United States
(12) Patent Application Publication
(10) Pub. No.: US 2016/0093262 A1
(43) Pub. Date: Mar. 31, 2016

(54) DISPLAY DRIVER IC FOR SELECTIVELY CONTROLLING 3-DIMENSIONAL MODE

(71) Applicant: SAMSUNG ELECTRONICS CO., LTD., Suwon-si (KR)

(72) Inventors: Sungpil CHOI, Yongin-si (KR); Soojin PARK, Suwon-si (KR); Suhyun PARK, Hwaseong-si (KR); Myoungsik SUH, Hwaseong-si (KR); Eunjong JANG, Osan-si (KR)

(21) Appl. No.: 14/859,685

(22) Filed: Sep. 21, 2015

(30) Foreign Application Priority Data
Sep. 29, 2014 (KR) 10-2014-0130490

(51) Int. Cl. G09G 3/36

(52) U.S. Cl. CPC G09G 3/3688; G09G 3/3648; G09G 2310/027

(57) ABSTRACT

A display driver IC includes an external pin to receive a select signal and a liquid crystal display device. The display device is selectively operated in a first mode or a second mode based on the level of the select signal for 3-dimensional display. The liquid crystal display device includes a timing controller to generate control signals, a source driver to convert digital data to a pixel voltage, and a panel to display an image.

### CROSS-REFERENCE TO RELATED APPLICATION

Korean Patent Application No. 10-2014-0130490, filed on Sep. 29, 2014, and entitled: “Display Driver IC For Selectively Controlling 3-Dimensional Mode,” is incorporated by reference herein in its entirety.

### BACKGROUND

1. Field

One or more embodiments described herein relate to a display driver integrated circuits (IC) for selectively controlling a 3-dimensional display mode.

2. Description of Related Art

Demand for 3-dimensional (3D) displays has steadily been increasing. One type of 3D display is a binocular parallax display which displays a left eye image to a left eye and a right eye image to a right eye. Thus, each of the left and right eyes can see a different 2-dimensional (2D) image. When each of the two 2D images is transmitted to the brain through the retinas, the brain reproduces a realistic sense of an original 3D image after merging the two 2D images.

A 3D display may operate using a time division method or a space division method. The time division method implements a 3D image by temporally dividing the left eye image and the right eye image. The space division method implements the 31) image by spatially dividing the left eye image and the right eye image.

These methods have different display qualities and/or frame frequencies. As a result, different solutions have been applied to displays that operate using time and space division methods, and also separate products for these methods have been developed and released. Consequently, there are difficulties with respect to development time, costs, and standardization of the separate products.

### SUMMARY

In accordance with one or more embodiment, a display driver IC which includes an external pin to receive a select signal; and a liquid crystal display device to be selectively operated in a first mode or a second mode according to a level of the select signal applied to the external pin in a 3-dimensional (3D) display, wherein the liquid crystal display device includes: a timing controller to generate control signals; a source driver to convert digital data to a pixel voltage; and a panel to display an image.

The liquid crystal display device may be driven as the first mode when the select signal is a first level, and the liquid crystal display device may be driven as the second mode when the select signal is a second level. The first level and the second level may be reverse levels. The liquid crystal display device may be operated after changing a frequency efficiency of data according to whether the first mode is driven or the second mode is driven. The liquid crystal display device may be controlled to be a lower data frequency when the second mode is driven compared to when the first mode is driven.

In accordance with one or more other embodiments, a display driver IC includes a plurality of external pins: and a liquid crystal display device to switch a display mode of a 3D display while displaying frames, the liquid crystal display device being controlled through one of the plurality of external pins. The one of the plurality of external pins may receive a select signal. The liquid crystal display device may selectively drive the display mode as a first mode or as a second mode in response to a level of the select signal. The liquid crystal display device may be operated after changing a frequency efficiency of data according to whether the first mode is driven or the second mode is driven.

The liquid crystal display device may include a panel including a plurality of unit pixels arranged in a matrix shape at intersections of a plurality of gate lines and a plurality of source lines; a timing controller to generate a plurality of control signals for controlling the panel; a source driver to be controlled by the control signals generated from the timing controller, and to convert digital data to a pixel voltage that is to be provided to the source line; and a first gate driver IC and a second gate driver IC to control driving of the gate lines, the first and second gate driver ICs being respectively and separately disposed on one end and the other end of the panel, the first and second gate driver ICs being connected to the plurality of gate lines.

The timing controller is to provide first to fourth clock pulse vertical signals to the first and second gate driver ICs. The first gate driver IC may be connected to gate lines of odd rows among the plurality of gate lines, and the second gate driver IC may be connected to gate lines of even rows among the plurality of gate lines.

When the select signal is a first level, two clock pulse vertical signals among the plurality of clock pulse vertical signals may be enabled, and the gate lines connected to the first gate driver IC and the gate lines may be connected to the second gate driver IC are controlled to be sequentially enabled. When the select signal is a second level having a reverse level as to the first level, all of the plurality of clock pulse vertical signals may be enabled, and some of the gate lines connected to the first gate driver IC and the gate lines may be connected to the second gate driver IC are controlled to be simultaneously selected and enabled. The select signal may be changed during a time during which frames of the liquid crystal display device are distinguished

In accordance with one or more other embodiments, a portable electronic device includes a memory device; a memory controller to control the memory device; an application processor; and a display driver IC, wherein the display driver IC includes: an external pin to which a select signal is applied; and a liquid crystal display device to switch a 3D mode and to change a data frequency by controlling an enable time of a plurality of gate lines and the number of selected gate lines according to the select signal.

The liquid crystal display device may include a panel including a plurality of unit pixels arranged in a matrix shape at intersections of the plurality of gate lines and a plurality of source lines; a timing controller to generate a plurality of control signals for controlling the panel; a source driver to be controlled by the control signals generated from the timing controller, and to convert digital data to a pixel voltage that is to be provided to the source line; and a first gate driver IC and a second gate driver IC to control driving of the plurality of gate lines, the first and second gate driver ICs being respectively and separately disposed one end and the other end of the panel, the first and second gate driver ICs being connected to the plurality of gate lines.

The first gate driver IC may be connected to gate lines of odd rows among the plurality of gate lines, and the second gate driver IC may be connected to gate lines of even rows among the plurality of gate lines. When the select signal is a first level, the gate lines may be connected to the first gate driver IC and the gate lines may be connected to the second gate driver IC are controlled to be sequentially enabled. When the select signal is a second level having a reverse level as to the first level, some of the gate lines may be connected to the first gate driver IC and the gate lines connected to the second gate driver IC are simultaneously selected and enabled, and may be controlled to have an longer enable time of the gate lines compared to when the select signal is the first level.

### BRIEF DESCRIPTION OF THE DRAWINGS

Features will become apparent to those of skill in the art by describing in detail exemplary embodiments with reference to the attached drawings in which:

FIG. 1 illustrates a view of a large-size panel including a defect;

FIG. 2A illustrates a view of a left-right (LR) driving method, and FIG. 2B illustrates a view of a black frame insertion method;

FIG. 3 illustrates a liquid crystal display device using an LR driving method;

FIG. 4 illustrates a relationship between signal performance and location;

FIG. 5 illustrates an embodiment of a display driver IC (DDI);

FIG. 6A illustrates an embodiment of an LR driving method, and FIG. 6B illustrates an embodiment of a timing diagram for the method of FIG. 6A;

FIG. 7A illustrates an embodiment of an LBRB driving method, and FIG. 7B illustrates an embodiment of a timing diagram for the method in FIG. 7A;

FIG. 8 illustrates an embodiment of operations for the DDI in FIG. 5;

FIG. 9 illustrates an embodiment of a computer system including the DDI in FIG. 5;

FIG. 10 illustrates another embodiment of a computer system including the DDI in FIG. 5; and

FIG. 11 illustrates an embodiment of a computer system including the DDI in FIG. 5.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, exemplary embodiments of the present disclosure that are easily performed by those skilled in the art will be described in detail with reference to the accompanying drawings. In detailed descriptions of the exemplary embodiments of the present disclosure, detailed descriptions of well-known configurations unrelated to the gist of the present disclosure will be omitted. In this specification, when reference numerals are assigned to components of each drawing, it should be noted that, although the same components are illustrated in different drawings, the same numerals are assigned as much as possible.

Specific structural and functional details disclosed herein are merely representative for purposes of describing example embodiments of the present disclosure, however, example embodiments of the present disclosure may be embodied in many alternate forms and should not be construed as limited to example embodiments of the present disclosure set forth herein.

While the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

It will be understood that, although the terms “first,” “second,” etc. may be used herein to describe various components, these components should not be limited by these terms. These terms are only used to distinguish one component from another component. Thus, a first component discussed below could be termed a second component and the second component discussed below could be termed the first component without departing from the teachings of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when it is possible to implement any embodiment in any other way, a function or an operation specified in a specific block may be performed differently from a flow specified in a flowchart. For example, two consecutive blocks may actually perform the function or the operation simultaneously, and the two blocks may perform the function or the operation conversely according to a related operation or function.

Hereinafter, the present disclosure will now be described more fully with reference to the accompanying drawings, in which embodiments of the present disclosure are shown.

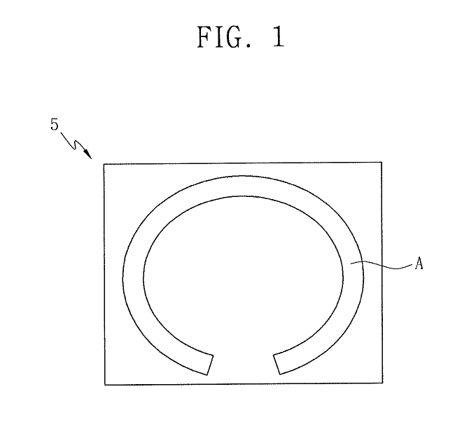

FIG. 1 illustrates a view of a defect which that may occur in a large-size panel 5. Referring to FIG. 1, a signal distortion shape A may be generated in a part of the large-size panel 5. In the case of the large-size panel such as FIG. 1, a defect displayed in “white” in a certain region may be generated and thus display quality may be degraded.

The above-described phenomenon should be highlighted increasingly as a panel size becomes larger. For example, the phenomenon may be generated by a signal mismatch between a gate driver IC and a gate line due to a characteristic of a long panel in an X-axis direction, i.e., a major axis direction.

For example, an output level of a pixel that is close to a gate driver IC should be different from an output level of a pixel that is far away from the gate driver IC. Thus, the defect displayed in “white” in the prescribed region may occur.

The above-described problem may be shown as the same aspect without any difference in panels using a left-right (LR) driving method and a left-black-right-black (LBRB) driving method which are driving methods of the panels.

First, the LR driving method and the LBRB driving method, which are driving methods of the panels, are described with reference to following drawings.

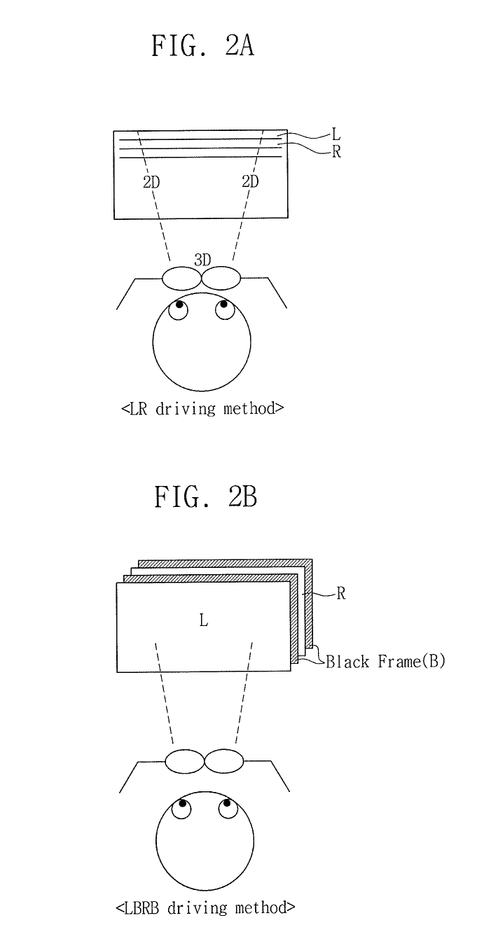

FIG. 2A illustrates a view conceptually illustrating a general LR driving method.

Referring to FIG. 2A, when a left eye image and a right eye image are sequentially displayed in a frame, a 3D image may be shown through 3D glasses. That is, in the LR driving method, the 3D image may be displayed by a method of alternately displaying a left eye 2D image and a right eye 2D image using a line inversion method with respect to a frame.

However, in the above-described display method, a motion blur phenomenon, or crosstalk in which an afterimage is generated may be generated during a time during which the left eye image is changed into the right eye image, or the right eye image is changed into the left eye image. Thus, watching a display device can cause a degree of fatigue. To reduce the above-described problems, a method as shown in FIG. 2B may be introduced.

FIG. 2B illustrates a view conceptually illustrating a general black frame insertion method. Referring to FIG. 2B, the 3D image may be completely formed by inserting a black frame between the left eye frame and the right eye frame.

That is, the black frame may be displayed after displaying the left eye frame, and then the right eye frame may be displayed. Since the black frame is alternately displayed between frames displaying actual images, afterimages between the actual frames may be removed, and a degree of fatigue may be reduced. The above-described method is generally referred to as an LBRB driving method.

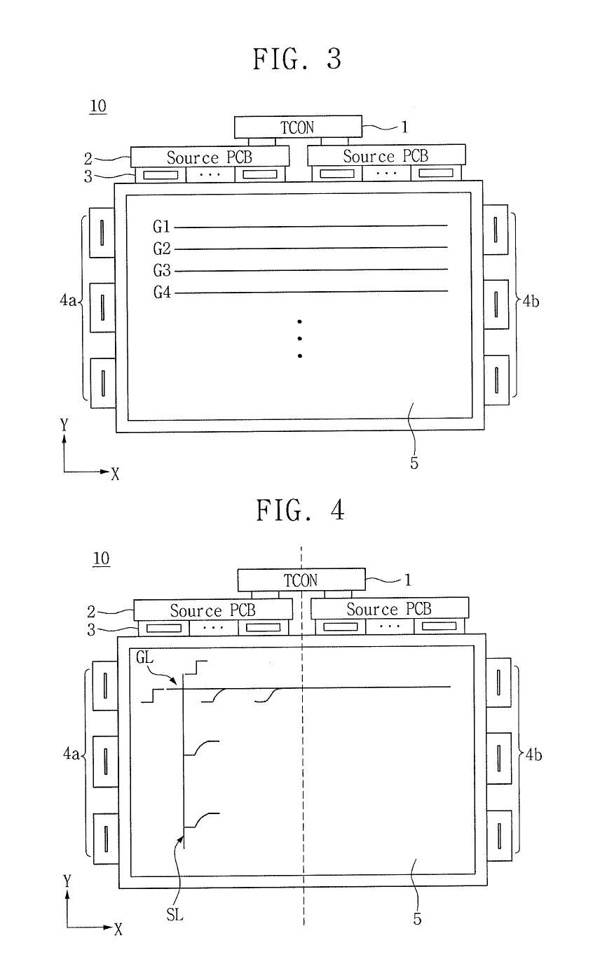

FIG. 3 illustrates a block diagram of a general liquid crystal display device 10 using an LR driving method. Referring to FIG. 3, the liquid crystal display device 10 may include a timing controller 1, a source driver PCB 2, a source driver 3, first and second gate driver ICs 4a and 4b, and a panel 5.

The timing controller 1 may generate and provide various control signals, which control the source driver 3 and the first and second gate driver ICs 4a and 4b, in order to control an operation of the panel 5.

The source driver PCB 2 may provide a display control signal. For example, a gamma voltage and a common voltage may be generated and provided.

The source driver 3 may be attached and formed on a connection member, for example, on a film type, and may apply a data voltage to a unit pixel of the panel 5.

The first gate driver IC 4a and the second gate driver IC 4b may be separately arranged on both sides of the panel 5.

Therefore, a first gate line group G1, G3, and the like extending in an X-axis direction of the panel 5 may be connected to the first gate driver IC 4a. Further, a second gate line group G2, G4, and the like may be connected to the second gate driver IC 4b.

The liquid crystal display device 10 may display a 3D image by driving left eye gate lines, that is, the first gate line group G1, G3 and the like, and by continuously driving right eye gate lines, that is, the second gate line group G2, G4 and the like.

Meanwhile, FIG. 4 illustrates a view showing a schematic concept with respect to a relationship between signal performance and locations according to FIG. 3. Referring to FIG. 4, when based on one gate line, a slew rate of a signal may be decreased as a location of a pixel becomes further away in an extending direction of the gate line, that is, the location of the pixel becomes further away from the gate driver IC which is a driver.

Further, when based on one source line, the slew rate of the signal may be decreased as the location of the pixel becomes further away in an extending direction of the source line (i.e., a Y direction), that is, the location of the pixel becomes further away from the source driver IC which is a driver.

Since the decreased slew rate is caused by RC resistance which should be present in a signal line, signal transmission may be delayed as the location of the pixel becomes further away from each driver.

Thus, the panel defect A, which is described with reference to FIG. 1, may be generated due to an effect of the RC resistance. Accordingly, although RC parasitic resistance of a drive line is compensated by decreasing on-resistance of the gate driver IC as the panel size is increased, the defect may be difficult to remove due to a structural characteristic of the panel in which a major axis is longer than a minor axis.

In case of a large-size panel, when the LR driving method is applied to a panel to display an image, display quality may be degraded because a defect which is displayed as white in a prescribed region is generated.

When the LBRB driving method is applied, a frame frequency thereof needs to be 4 times higher than that of the LR driving method in order to display an image identical to an image generated by the LR driving method (for example, 60 Hz when using the LR driving method and 240 Hz when using the LBRB driving method). Thus, a white crosstalk phenomenon may become worse due to a limitation of a high signal frequency required in the LBRB driving method.

According to current techniques, since each method of controlling a gate driver and a frame frequency is different with respect to the LR driving method and the LBRB driving method have, a liquid crystal display device using the LR driving method and a liquid crystal display device using the LBRB driving method should be produced as separate products.

However, in some images, although using the LR driving method to display the images, afterimages may not significantly arise. Thus, although specific images are desired to be selectively displayed by controlling the LBRB driving method, in the conventional case, separate products may not be compatible because the products are produced by each driving method as described above.

Furthermore, the remarkable white crosstalk phenomenon generated in the LBRB method should be reduced.

In accordance with the embodiment of the present disclosure, a display driver IC (DDI), in which a fundamental problem of the white crosstalk phenomenon generated from a large-size panel is removed and an LR mode and an LBRB mode may be selectively controlled, is disclosed.

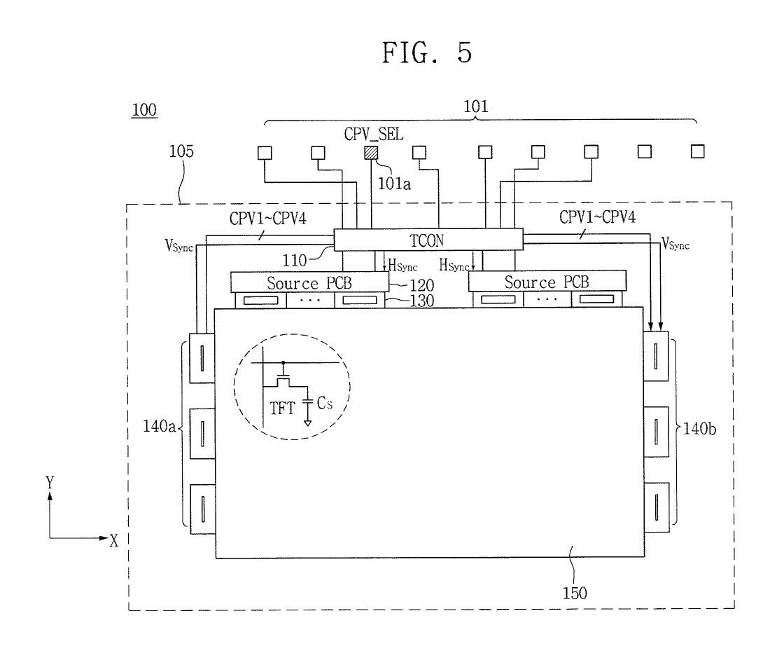

FIG. 5 illustrates an embodiment of a DDI 100 which includes an external pin group 101 and a liquid crystal display device 105. Here, a liquid crystal display device is described as a display device in the embodiment, but the display device is not limited thereto and may be applied to flat panel display devices such as an electroluminescent (EL) device, an electrophoresis display (EPD) device, and the like, which may include a field emission display (FED), a plasma display panel (PDP), an inorganic electroluminescent device, and/or an organic light emitting diode (OLED) device.

First, as the external pin group 101 may include a plurality of pins formed outside the liquid crystal display device 105, the external pin group 101 may receive signal externally. In particular, the DDI 100 according to the embodiment of the present disclosure may include a pin 101a to which a clock pulse vertical (CPV) select signal CPV_SEL may be applied. As the CPV select signal CPV_SEL selects a high level signal or a low level signal, and is applied to the CPV select signal pin 101a, the liquid crystal display device 105 may be controlled to display in an LR mode or an LBRB mode.

The liquid crystal display device 105 may control the CPV select signal CPV_SEL in order to display by the LBRB driving method when the CPV select signal CPV_SEL is at a high level, and may display by the LR driving method when the CPV select signal CPV_SEL is at a low level.

The liquid crystal display device 105 may include a timing controller 110, a source driver PCB 120, a source driver 130, first and second gate driver ICs 140a and 140b, and a panel 150.

The timing controller 110 may generate and provide various control signals, which control the source driver 130 and the first and second gate driver ICs 140a and 140b, so as to control an operation of the panel 150. For example, the timing controller 110 may provide first and second start signals STV1 and STV2, and a plurality of clock pulse vertical (CPV) signals CPV1 to CPV4. In particular, the timing controller 110 according to the embodiment of the present disclosure may provide the first to fourth CPV signals CPV1 to CPV4 to the first and second gate driver ICs 140a and 140b. Further, the timing controller 110 may provide a vertical sync signal Vsync and a horizontal sync signal Hsync to the first and second gate driver ICs 140a and 140b and the source driver 130, respectively. Although not shown, the timing controller 110 may also provide a data control signal, a clock signal, etc.

The source driver PCB 120 may provide a display control signal. For example, a gamma voltage and a common voltage may be generated and provided. Meanwhile, the timing controller 110 and the source driver PCB 120 may be connected by a connection member 111 (not shown).

The source driver 130 may be attached and formed on the connection member, for example, on a film type, and may convert digital data to a pixel voltage that is to be provided to a source line of the panel 150.

The first gate driver IC 140a and the second gate driver IC 140b may be separately formed on both sides of the panel 150.

Therefore, a first gate line group G1, G3, G5, G7, G9, and the like extending in an X-axis direction of the panel 150 may be connected to the first gate driver IC 140a. Further, a second gate line group G2, G4, G6, G8, G10, and the like may be connected to the second gate driver IC 140b. That is, gate lines in odd rows may be connected to the first gate driver IC 140a, and gate lines in even rows may be connected to the second gate driver IC 140b.

The gate lines which are selected and controlled by each gate driver IC 140a and 140b may be changed by the CPV select signal CPV_SEL. This will be described in detail using a table below.

Subsequently, the panel 150 may receive a display control signal and may display an image. The panel 150 may generally include a plurality of unit pixels arranged in a matrix shape at intersections of the plurality of gate lines and the plurality of source lines. Here, descriptions will be simply described with one unit pixel.

The unit pixel may include a switching device TFT connected to one gate line and one source line, and a liquid crystal capacitor Cs connected to the switching device TFT. In particular, the liquid crystal capacitor Cs may have two terminals connected to a drain terminal of the switching device TFT and a common voltage, and a dielectric layer having a dielectric anisotropy may be formed between the two terminals.

In an operation of the unit pixel, a pixel voltage applied to a source line from the source driver 130 may be transmitted to the drain terminal of the switching device TFT through the switching device TFT which is turned on. Thus, a state of a liquid crystal orientation of a liquid crystal cell may be changed by an electric field applied to the liquid crystal capacitor Cs, and an image may be displayed.

In accordance with the embodiment of the present disclosure, as the CPV select signal CPV_SEL is applied, the LR driving method and the LBRB driving method may be selectively controlled in one DDI 100.

When the CPV select signal CPV_SEL is at a low level, the timing controller 110 may provide enabled first and third CPV signals CPV1 and CPV3. Therefore, the first gate driver IC 140a may drive left eye gate lines, that is, the first gate line group G1, G3, G5, and the like, in response to the first CPV signal CPV1. Subsequently, the second gate driver IC 140b may drive right eye gate lines, that is, the second gate line group G2, G4, G6, and the like, in response to the third CPV signal CPV3, and may provide a 3D image. Thus, in accordance with the embodiment of the present disclosure, when the CPV select signal CPV_SEL is at a low level, each gate line may be controlled to be sequentially enabled.

When the CPV select signal CPV_SEL is at a high level, the first gate driver IC 140a may select and drive predetermined gate lines from the first gate line group in response to the first CPV signal CPV1. For example, the predetermined gate lines may be G1, G5, G9, and the like (i.e., a rule of 4n−3). At the same time, the second gate driver IC 140b may select and drive predetermined gate lines, for example, G2, G6, G10, and the like (i.e., a rule of 4n−2), from the second gate line group in response to the third CPV signal CPV3.

Subsequently, the first gate driver IC 140a may select and drive predetermined gate lines from the first gate line group in response to the second CPV signal CPV2. For example, G3, G7, G11, and the like (i.e., a rule of 4n−1) may be selected and driven. Further, the second gate driver IC 140b may select and drive predetermined gate lines, for example, G4, G8, G12, and the like (i.e., a rule of 4n), from the second gate line group in response to the fourth CPV signal CPV4. The above descriptions are summarized in the following Table 1.

TABLE 1

| | When CPV_SEL is at a low | When CPV_SEL is at a high |
|---|---|---|
| CPV No. | level | level |
| CPV1 | G1, G3, G5 . . . | G1, G5, G9 . . . |
| CPV2 | Not activated | G3, G7, G11 . . . |
| CPV3 | G2, G4, G6 . . . | G2, G6, G10 . . . |
| CPV4 | Not activated | G4, G8, G12 . . . |

When the DDI 100 according to the embodiment of the present disclosure displays a 3D image, selection of a method of driving an internal display panel may be controlled by applying the CPV select signal CPV_SEL to an external pin.

When the CPV select signal CPV_SEL is at a high level, the timing controller 110 may provide the first CPV to fourth CPV signals CPV1 to CPV4 so as to be displayed by the LBRB driving method. When the CPV select signal CPV_SEL is at a low level, the timing controller 110 may enable only the first CPV signal CPV1 and the third CPV signal CPV3 and may disable the second CPV signal CPV2 and the fourth CPV signal CPV4 so as to be displayed by the LR driving method.

In particular, the DDI 100 according to the embodiment of the present disclosure may change a data bandwidth by increasing the number of gate lines simultaneously selected when the CPV select signal CPV_SEL is at a high level. Thus, the DDI 100 may be a single product capable of supporting both the LR driving method and the LBRB driving method instead of separate products, and, thereby, a utilization rate of the product may be increased because mode selection between the LR driving method and LBRB driving method is free, and a frequency efficiency of data may also be controlled to be changeable.

In accordance with the embodiment of the present disclosure, a hybrid mode may be implemented, and then a 3D mode may be changeable according to a request of an end user.

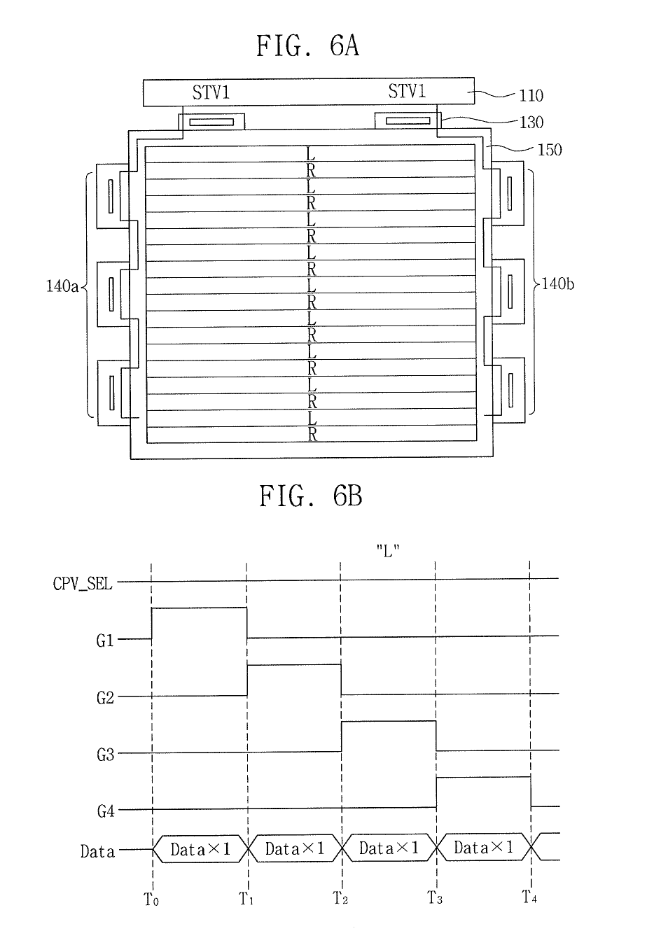

FIG. 6A illustrates a view illustrating the LR driving method according to FIG. 5, and FIG. 6B illustrates a timing diagram illustrating operations according to FIG. 6A. Referring to FIGS. 6A and 6B, a timing controller 110 may provide a first start signal STV1. The enabled first start signal STV1 may enable first and second gate driver ICs 140a and 140b. Here, a method in which the first start signal STV1 is provided to the first and second gate driver ICs 140a and 140b may be a cascade method.

Operation of each of the first and second gate driver ICs 140a and 140b may be ready to respond to the enabled first start signal STV1.

Since a CPV select signal CPV_SEL is at a low level, first and third CPV signals CPV1 and CPV3 may be enabled in response to the first start signal STV1. The first and third CPV signals CPV1 and CPV3 may be provided to the first and second gate driver ICs 140a and 140b. Further, the first and third CPV signals CPV1 and CPV3 may be provided as a multi-driving method.

A panel 150 may be operated by a line inversion method so as to display a left eye image and a right eye image.

The first gate driver IC 140a may enable a first gate line G1 for a period of T0 to T1 in response to the first CPV signal CPV1. Data Datax1 having a predetermined bandwidth may be output during a predetermined time, that is, the period of T0 to T1.

Subsequently, the second gate driver IC 140b may enable a second gate line G2 for a period of T1 to T2 in response to the third CPV signal CPV3. Also, data Datax1 having a predetermined bandwidth may be output during the period of T1 to T2.

Subsequently, the first gate driver IC 140a may enable a third gate line G3 for a period of T2 to T3 in response to the first CPV signal CPV1.

The second gate driver IC 140b may enable a fourth gate line G4 for a period of T3 to T4 in response to the third CPV signal CPV3.

As described above, in accordance with the embodiment of the present disclosure, when the CPV select signal CPV_SEL is at a low level, gate lines may be sequentially driven so as to become a line inversion method. Thus, the LR mode may be driven in accordance with the embodiment of the present disclosure.

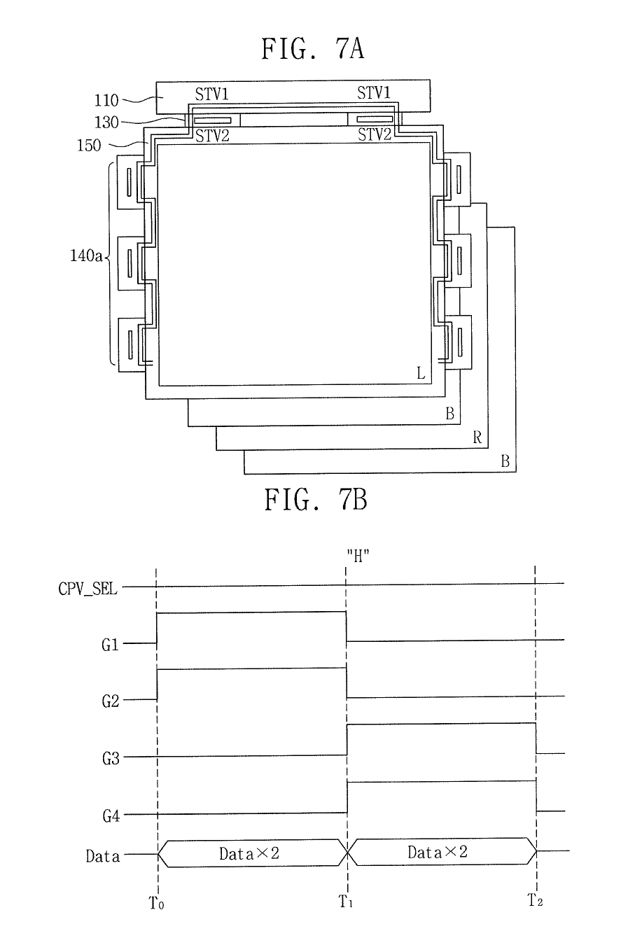

FIG. 7A illustrates a view of an example of the LBRB driving method according to FIG. 5 and FIG. 7B illustrates a timing diagram illustrating operations thereof. Referring to FIGS. 7A and 7B, a timing controller 110 may provide a first start signal STV1 and a second start signal STV2. The first start signal STV1 and the second start signal STV2 which are enabled may enable first and second gate driver ICs 140a and 140b.

Operation of each of the first and second gate driver ICs 140a and 140b may be ready to respond to the first start signal STV1 and the second start signal STV2 which are enabled.

Here, as a CPV select signal CPV_SEL is at a high level, all of first to fourth CPV signals CPV1 to CPV4 may be enabled in response to the first start signal STV1 and the second start signal STV2 which are enabled.

The first gate driver IC 140a may enable a first gate line G1 for a period of T0 to T1 in response to the first CPV signal CPV1. Here, a high duration may be extended by extending an enabled period of the first gate line G1 to a predetermined time.

At the same time, the second gate driver IC 140b may enable a second gate line G2 for a period of T0 to T1 in response to the third CPV signal CPV3.

Since data is fully transmitted during the period of T0 to T1 and the number of gate lines is simultaneously increased, a data bandwidth may be increased compared to a general case.

The first gate driver IC 140a may enable a third gate line G3 for a period of T1 to T2 in response to the second CPV signal CPV2.

Further, the second gate driver IC 140b may enable a fourth gate line G4 for a period of T1 to T2 in response to the third CPV signal CPV3. A high duration of each enabled gate line may be controlled to substantially be the same.

As described above, in accordance with the embodiment of the present disclosure, the LBRB drive mode can be implemented.

The DDI (see 100 in FIG. 5) according to the embodiment of the present disclosure may control to increase the number of gate lines which are enabled at the same time, when the CPV select signal CPV_SEL is at a high level. For example, the first gate line G1 and the second gate line G2 may be simultaneously enabled. This is an achievable scheme because this is not the LR driving method using line inversion.

In general, a method of increasing a data bandwidth may be a method of generating more clock pulses within the same time by reducing a high duration, i.e., reducing latency, of a pulse. However, in this case, a charge time of a capacitor may be issued in consideration of a long line of a large-size panel.

Another method of increasing the data bandwidth may increase the data bandwidth by increasing the number of selected data. Increasing the number of the selected data may be accomplished by increasing the number of gate lines which are enabled at the same time.

In accordance with the embodiment of the present disclosure, when the LBRB mode is started, two gate lines may be controlled to be simultaneously enabled and the data bandwidth during the same time may be controlled not to decrease even when latency is increased, by extending a drive time (a high duration) of the gate to a predetermined time.

In accordance with the embodiment of the present disclosure, both the LR mode and the LBRB mode may be implemented, and the white crosstalk phenomenon may also be prevented by fully driving gate lines within a predetermined time without a loss of the data bandwidth in the LBRB mode.

Meanwhile, the first gate line G1 and the second gate line G2 may be synchronized to have the same enabled time for convenience, but the gate lines may be controlled by an interleaving method with a predetermined time interval according to an intention of a designer.

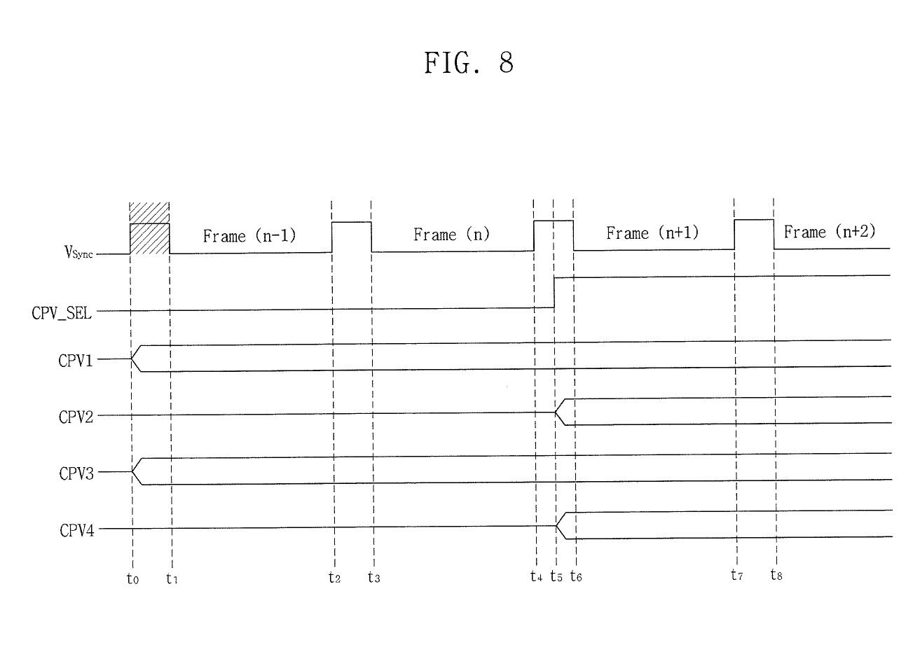

FIG. 8 illustrates a timing diagram illustrating operations according to FIG. 5. Referring to FIG. 8, FIG. 8 illustrates an example in which a 3D mode is changed according to a CPV select signal CPV_SEL.

The present disclosure may provide either a case that an end user wants to change a mode to display another image while displaying an image, as described above, or a case that a developer of a display module wants to change the mode to display a test image.

First, a vertical sync signal Vsync may be enabled for a period of t0 to t1. As the period of t0 to t1 is a preparation time to enable gate drivers (see 140a and 140b in FIG. 5), an actual image may not be displayed. A time for which the vertical sync signal Vsync is enabled may be considered as a time for which each frame is distinguished. At this time, the CPV select signal CPV_SEL is at a low level.

Thus, when an LR drive mode is started, first and third CPV signals CPV1 and CPV3 may be enabled.

The vertical sync signal Vsync may be enabled for a period of t1 to t2. The CPV select signal CPV_SEL may be still at a low level. Thus, the first and third CPV signals CPV1 and CPV3 may be enabled.

Different frames Frame (n−1) and Frame (n) may be displayed for periods of t1 to t2 and t3 to t4, respectively. This case is displayed as the LR mode.

When the vertical sync signal Vsync is enabled for a period of t4 to t6, a level of the CPV select signal CPV_SEL may be changed. That is, the CPV select signal CPV_SEL may be transitioned to a high level at time t5. This denotes that the 3D mode is switched from the LR drive mode to an LBRB mode.

The LBRB mode may be operated for a period of t6 to t7 and after time t8. Thus, a frame Frame (n+1) may be a left eye frame, and a frame Frame (n+2) may be a black frame. Although subsequent frames are not shown in FIG. 8, it may sequentially be a right eye frame and the black frame.

The 3D mode may be switched for a period in which no frame is displayed, for example, a period for which the vertical sync signal Vsync is enabled. This indicates it may switch a mode from the LR mode to the LBRB mode while displaying frames.

As described above, in accordance with the embodiment of the present disclosure, as the plurality of CPV signals are selectively controlled using the CPV select signal CPV_SEL, the LR drive mode and the LBRB drive mode may be selected.

In case of a data frequency, the LBRB mode may have a half data frequency of the LR mode. However, since the number of gate lines which are simultaneously selected is increased twice, a loss of a data bandwidth may be prevented.

Accordingly, the LBRB mode according to the embodiment of the present disclosure may provide a display device in which display quality is improved.

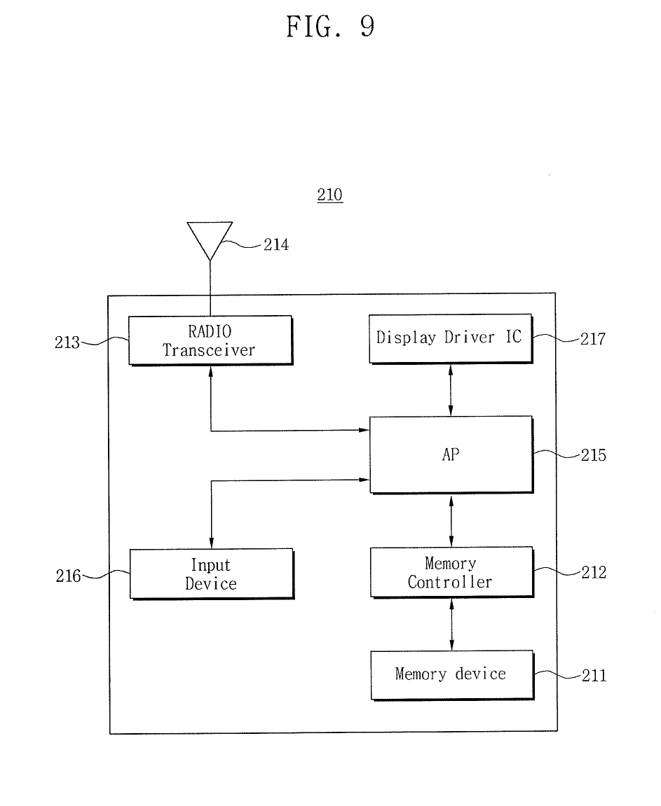

FIG. 9 illustrates a block diagram illustrating a computer system 210 including the DDI 100 shown in FIG. 5 in accordance with an embodiment of the present disclosure. Referring to FIG. 9, the computer system 210 may include a memory device 211, a memory controller 212 which controls the memory device 211, a radio transceiver 213, an antenna 214, an application processor (AP) 215, an input device 216, and a DDI 217.

The radio transceiver 213 may exchange wireless signals through the antenna 214. For example, the radio transceiver 213 may convert the wireless signals that are received through the antenna 214 to signals that are to be processed in the AP 215.

Thus, the AP 215 may process an output signal from the radio transceiver 213, and the processed signal may be transmitted to the DDI 217. Further, the radio transceiver 213 may convert an output signal from the AP 215 to a wireless signal, and the converted wireless signal may be output to an external device through the antenna 214.

The input device 216 may be a device which may input a control signal for controlling an operation of the AP 215 or data processed in the AP 215. The input device 216 may be implemented as a pointing device such as a touch pad and computer mouse, a keypad, or a keyboard.

In some embodiments, the memory controller 212 which controls an operation of the memory device 211 may be implemented as a part of the AP 215, and may also be implemented as a chip separate from the AP 215.

In some embodiments, the DDI 217 may be implemented as the DDI 100 shown in FIG. 5 and may serve to drive a 3D hybrid mode.

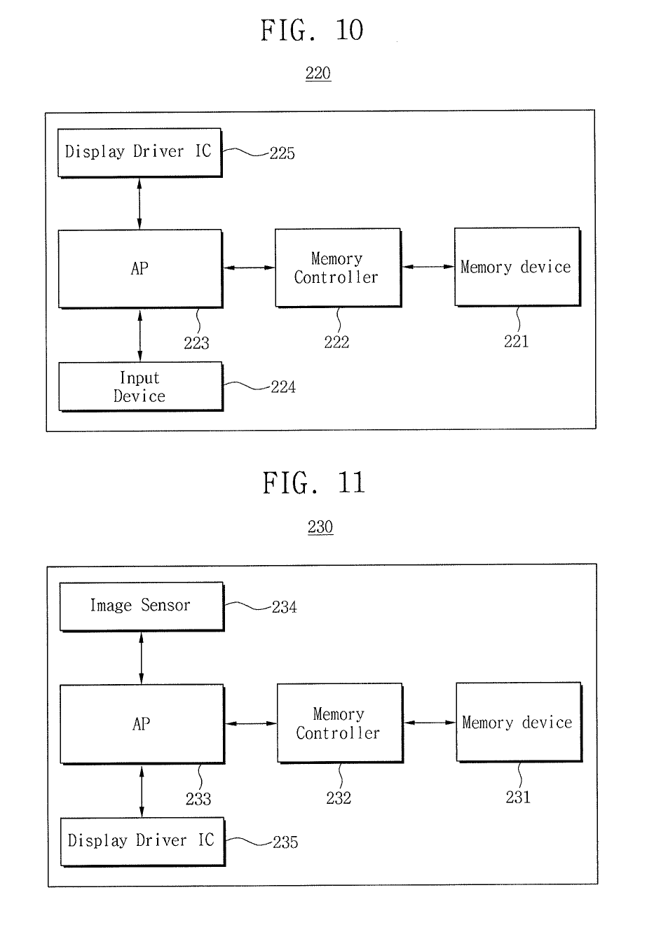

FIG. 10 illustrates a block diagram illustrating a computer system 220 including the DDI 100 shown in FIG. 5 in accordance with another embodiment of the present disclosure. Referring to FIG. 10, the computer system 220 may be implemented as a personal computer (PC), a network server, a tablet PC, a net-book, an e-reader, a personal digital assistant (PDA), a portable multimedia player (PMP), an MP3 player, or an MP4 player.

The computer system 220 may include a memory device 221, a memory controller 222 which controls a data processing operation of the memory device 221, an AP 223, an input device 224, and a DDI 225.

The AP 223 may display data stored in the memory device 221 through the DDI 225 according to data input through the input device 224. For example, the input device 224 may be implemented as a pointing device such as a touch pad or computer mouse, a key pad, or keyboard. The AP 223 may control an overall operation of the computer system 220, and may control an operation of the memory controller 222.

In some embodiments, the memory controller 222 which controls an operation of the memory device 221 may be implemented as a part of the AP 223, and may also be implemented as a chip separate from the AP 223.

In some embodiments, the DDI 225 may be implemented as the DDI 100 shown in FIG. 5 and may serve to drive a 3D hybrid mode.

FIG. 11 illustrates a block diagram illustrating a computer system 230 including the DDI 100 shown in FIG. 5 in accordance with still another embodiment of the present disclosure. Referring to FIG. 11, the computer system 230 may be implemented as an image process device such as a digital camera or a mobile phone having the digital camera, a smart phone, or a tablet.

The computer system 230 may include a memory device 231 and a memory controller 232 which controls a data processing operation of the memory device 231, for example, a write operation or a read operation. Further, the computer system 230 may further include an AP 233, an image sensor 234, and a DDI 235.

The image sensor 234 in the computer system 230 may convert an optical image to digital signals, and may transmit the converted digital signals to the AP 233 or the memory controller 232. The converted digital signals may be displayed through the DDI 235 or stored in the memory device 231 through the memory controller 232 according to control of the AP 233.

Further, data stored in the memory device 231 may be displayed through the DDI 235 according to control of the AP 233 or the memory controller 232.

In some embodiments, the memory controller 232 which controls an operation of the memory device 231 may be implemented as a part of the AP 233, and may also be implemented as a chip separate from the AP 233.

In some embodiments, the DDI 235 may be implemented as the DDI 100 shown in FIG. 5 and may serve to drive a 3D hybrid mode.

The display driver IC according to the embodiment of the present disclosure, a mode between an LR driving method and an LBRB driving method can be freely selected, and product utilization can be high by variably controlling data frequency efficiency. The embodiment of the present disclosure may be applicable for a mobile device, and particularly, a buck converter and a memory system including the same.

The controller and other processing features of the aforementioned embodiments may be implemented in logic which, for example, may include hardware, software, or both. When implemented at least partially in hardware, the controller and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controller and other processing features of the embodiments disclosed herein may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A display driver IC, comprising:
an external pin to receive a select signal; and
a liquid crystal display device to be selectively operated in a first mode or a second mode according to a level of the select signal applied to the external pin in a 3-dimensional (3D) display, wherein the liquid crystal display device includes:
a timing controller to generate control signals;
a source driver to convert digital data to a pixel voltage; and
a panel to display an image.

2. The display driver IC as claimed in claim 1, wherein:
the liquid crystal display device is driven as the first mode when the select signal is a first level, and
the liquid crystal display device is driven as the second mode when the select signal is a second level.

3. The display driver IC as claimed in claim 2, wherein the first level and the second level are reverse levels.

4. The display driver IC as claimed in claim 1, wherein the liquid crystal display device is operated after changing a frequency efficiency of data according to whether the first mode is driven or the second mode is driven.

5. The display driver IC as claimed in claim 4, wherein the liquid crystal display device is controlled to be a lower data frequency when the second mode is driven compared to when the first mode is driven.

6. A display driver IC, comprising:
a plurality of external pins; and
a liquid crystal display device to switch a display mode of a 3D display while displaying frames, the liquid crystal display device being controlled through one of the plurality of external pins.

7. The display driver IC as claimed in claim 6, wherein the one of the plurality of external pins is to receive a select signal.

8. The display driver IC as claimed in claim 7, wherein the liquid crystal display device is to selectively drive the display mode as a first mode or as a second mode in response to a level of the select signal.

9. The display driver IC as claimed in claim 8, wherein the liquid crystal display device is to be operated after changing a frequency efficiency of data according to whether the first mode is driven or the second mode is driven.

10. The display driver IC as claimed in claim 8, wherein the liquid crystal display device includes:
a panel including a plurality of unit pixels arranged in a matrix shape at intersections of a plurality of gate lines and a plurality of source lines;
a timing controller to generate a plurality of control signals for controlling the panel;
a source driver to be controlled by the control signals generated from the timing controller, and to convert digital data to a pixel voltage that is to be provided to the source line; and
a first gate driver IC and a second gate driver IC to control driving of the gate lines, the first and second gate driver ICs being respectively and separately disposed on one end and the other end of the panel, the first and second gate driver ICs being connected to the plurality of gate lines.

11. The display driver IC as claimed in claim 10, wherein the timing controller is to provide first to fourth clock pulse vertical signals to the first and second gate driver ICs.

12. The display driver IC as claimed in claim 11, wherein:
the first gate driver IC is connected to gate lines of odd rows among the plurality of gate lines, and
the second gate driver IC is connected to gate lines of even rows among the plurality of gate lines.

13. The display driver IC as claimed in claim 12, wherein, when the select signal is a first level, two clock pulse vertical signals among the plurality of clock pulse vertical signals are enabled, and the gate lines connected to the first gate driver IC and the gate lines connected to the second gate driver IC are controlled to be sequentially enabled.

14. The display driver IC as claimed in claim 13, wherein when the select signal is a second level having a reverse level as to the first level, all of the plurality of clock pulse vertical signals are enabled, and some of the gate lines connected to the first gate driver IC and the gate lines connected to the second gate driver IC are controlled to be simultaneously selected and enabled.

15. The display driver IC as claimed in claim 14, wherein the select signal is changed during a time during which frames of the liquid crystal display device are distinguished.

16. A portable electronic device, comprising:
a memory device;
a memory controller to control the memory device:
an application processor; and
a display driver IC, wherein the display driver IC includes:
an external pin to which a select signal is applied; and
a liquid crystal display device to switch a 3D mode and to change a data frequency by controlling an enable time of a plurality of gate lines and the number of selected gate lines according to the select signal.

17. The portable electronic device as claimed in claim 16, wherein the liquid crystal display device includes:
a panel including a plurality of unit pixels arranged in a matrix shape at intersections of the plurality of gate lines and a plurality of source lines;
a timing controller to generate a plurality of control signals for controlling the panel;
a source driver to be controlled by the control signals generated from the timing controller, and to convert digital data to a pixel voltage that is to be provided to the source line; and
a first gate driver IC and a second gate driver IC to control driving of the plurality of gate lines, the first and second gate driver ICs being respectively and separately disposed one end and the other end of the panel, the first and second gate driver ICs being connected to the plurality of gate lines.

18. The portable electronic device as claimed in claim 17, wherein:
the first gate driver IC is connected to gate lines of odd rows among the plurality of gate lines, and
the second gate driver IC is connected to gate lines of even rows among the plurality of gate lines.

19. The portable electronic device as claimed in claim 18, wherein:
when the select signal is a first level, the gate lines connected to the first gate driver IC and the gate lines connected to the second gate driver IC are controlled to be sequentially enabled.

20. The portable electronic device as claimed in claim 19, wherein:
when the select signal is a second level having a reverse level as to the first level, some of the gate lines connected to the first gate driver IC and the gate lines connected to the second gate driver IC are simultaneously selected and enabled, and are controlled to have an longer enable time of the gate lines compared to when the select signal is the first level.
